(19) United States
(12) Patent Application Publication
(10) Pub. No.: US 2024/0357322 A1
(43) Pub. Date: Oct. 24, 2024

(54) COMMUNICATION METHOD

(71) Applicant: KYOCERA CORPORATION, Kyoto (JP)

(72) Inventors: Masato FUJISHIRO, Yokohama-shi (JP); Henry CHANG, San Diego, CA (US)

(73) Assignee: KYOCERA CORPORATION, Kyoto (JP)

(21) Appl. No.: 18/763,050

(22) Filed: Jul. 3, 2024

Related U.S. Application Data
(63) Continuation of application No. PCT/JP2022/047339, filed on Dec. 22, 2022.
(60) Provisional application No. 63/296,238, filed on Jan. 4, 2022.

(51) Int. Cl. H04W 4/06

(52) U.S. Cl. CPC H04W 4/06

(57) ABSTRACT

A communication method performed by a user equipment in a mobile communication system for providing a multicast and broadcast service (MBS), the communication method including: receiving, from a base station, configuration information configuring a condition under which the user equipment is permitted to transmit, to the base station, an MBS interest indication regarding an MBS session that the user equipment is receiving or is interested in receiving; and performing transmission processing of the MBS interest indication in response to the condition configured by the configuration information being satisfied.

### RELATED APPLICATIONS

The present application is a continuation based on PCT Application No. PCT/JP2022/047339, filed on Dec. 22, 2022, which claims the benefit of U.S. Provisional Patent Application No. 63/296,238 filed on Jan. 4, 2022. The content of which is incorporated by reference herein in their entirety.

### TECHNICAL FIELD

The present disclosure relates to a communication method used in a mobile communication system.

### BACKGROUND OF INVENTION

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

In view of this, the present disclosure provides a communication method for enabling implementation of enhanced multicast and broadcast services.

A communication method according to a first aspect is a communication method performed by a user equipment in a mobile communication system for providing a multicast and broadcast service (MBS), the communication method including: receiving, from a base station, configuration information configuring a condition under which the user equipment is permitted to transmit, to the base station, an MBS interest indication regarding an MBS session that the user equipment is receiving or is interested in receiving; and performing transmission processing of the MBS interest indication in response to the condition configured by the configuration information being satisfied.

A communication method according to a second aspect is a communication method performed by a user equipment in a mobile communication system providing a multicast and broadcast service (MBS), the communication method including: transmitting, to a base station, a first MBS interest indication including information indicating, among a combination of a plurality of frequencies that the user equipment is capable of simultaneously receiving, one or more MBS frequencies that the user equipment is receiving or is interested in receiving; receiving, from the base station, carrier aggregation (CA) configuration information regarding a CA configuration; and transmitting a second MBS interest indication to the base station when the combination is changed according to the CA configuration information and the one or more MBS frequencies that the user equipment is receiving or interested in receiving are changed, the second MBS interest indication including information indicating a changed MBS frequency.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to the embodiment.

FIG. 3 is a diagram illustrating a configuration of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of MBS traffic delivery according to the embodiment.

FIG. 7 is a diagram illustrating delivery modes according to the embodiment.

FIG. 8 is a diagram illustrating an example of internal processing related to MBS reception of the UE according to the embodiment.

FIG. 9 is a diagram illustrating another example of the internal processing related to the MBS reception of the UE according to the embodiment.

FIG. 10 is a diagram for describing an overview of an MII.

FIG. 11 is a diagram illustrating a first operation example of the mobile communication system according to the embodiment.

FIG. 12 is a diagram for describing trigger configuration information in the first operation example of the mobile communication system according to the embodiment.

FIG. 13 is a diagram for describing trigger type information (trigger type ID) and prohibition time configuration information (prohibition timer value) in a second operation example of the mobile communication system according to the embodiment.

FIG. 14 is a diagram illustrating the second operation example of the mobile communication system according to the embodiment.

FIG. 15 is a diagram for describing the trigger type information (trigger type ID) and the prohibition time configuration information (prohibition timer value) in the second operation example of the mobile communication system according to the embodiment.

FIG. 16 is a diagram for describing the trigger type information (trigger type ID) and the prohibition time configuration information (prohibition timer value) in the second operation example of the mobile communication system according to the embodiment.

FIG. 17 is a diagram for describing trigger type information (trigger type ID) and dispersion information in a third operation example of the mobile communication system according to the embodiment.

FIG. 18 is a diagram for describing the trigger type information (trigger type ID) and the dispersion information in the third operation example of the mobile communication system according to the embodiment.

FIG. 19 is a diagram illustrating the third operation example of the mobile communication system according to the embodiment.

FIG. 20 is a diagram illustrating an operation of a UE according to a variation of the operation of the mobile communication system according to the embodiment.

### DESCRIPTION OF EMBODIMENTS

A mobile communication system according to an embodiment is described with reference to the drawings. In the description of the drawings, the same or similar parts are denoted by the same or similar reference signs.

### Configuration of Mobile Communication System

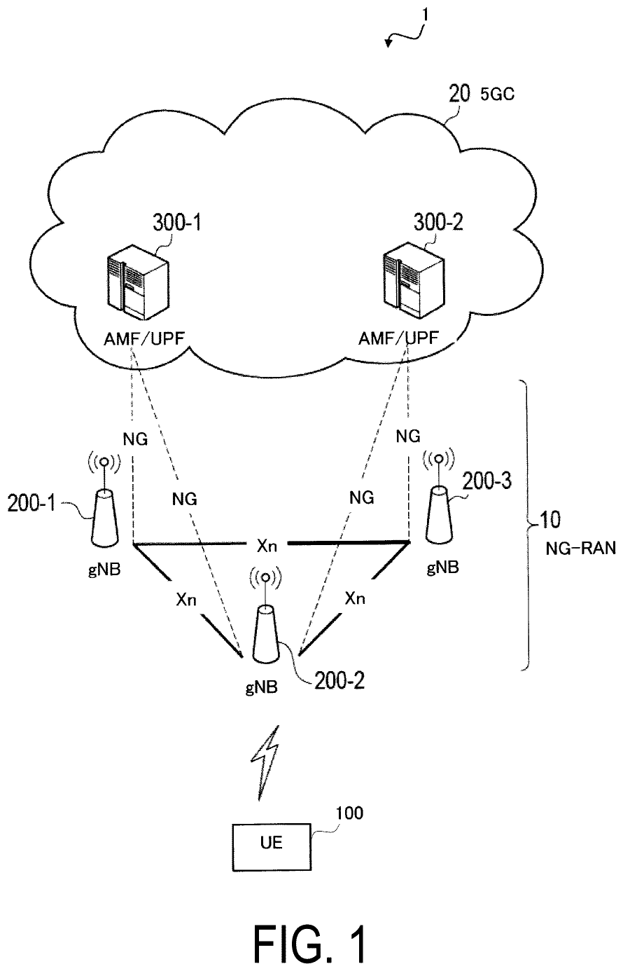

FIG. 1 is a diagram illustrating a configuration of a mobile communication system according to an embodiment. A mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided at a sensor, a vehicle or an apparatus provided at a vehicle (Vehicle UE), and a flying object or an apparatus provided at a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) being a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

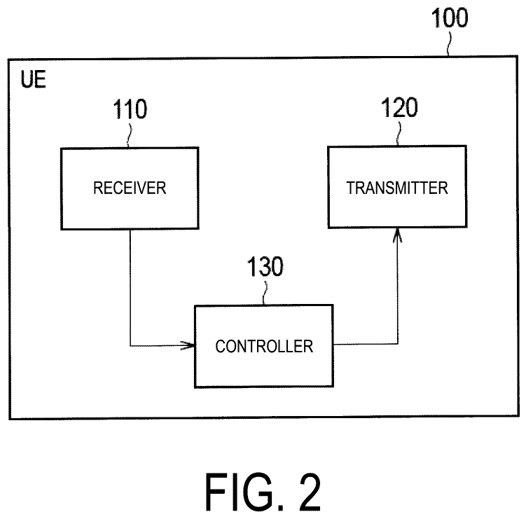

FIG. 2 is a diagram illustrating a configuration of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

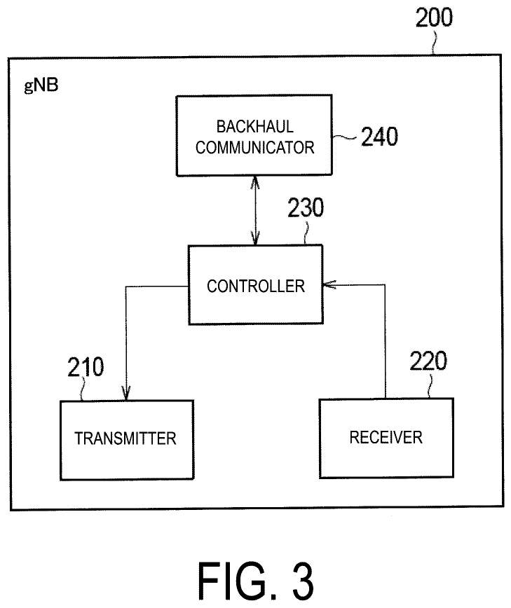

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface, which is an inter-base station interface. The backhaul communicator 240 is connected to the AMF/UPF 300 via a NG interface, which is an interface between the base station and the core network. Note that the gNB 200 may include a Central Unit (CU) and a Distributed Unit (DU) (i.e., functions are divided), and the two units may be connected via an F1 interface, which is a fronthaul interface.

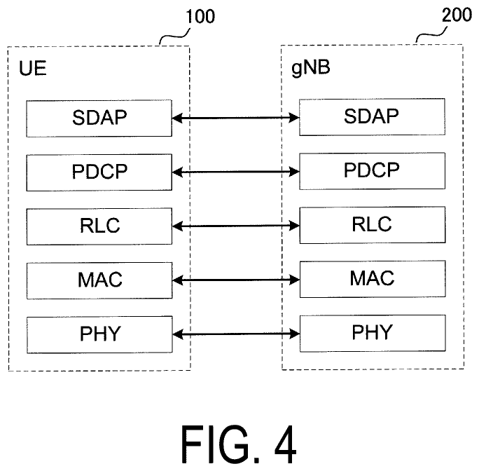

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

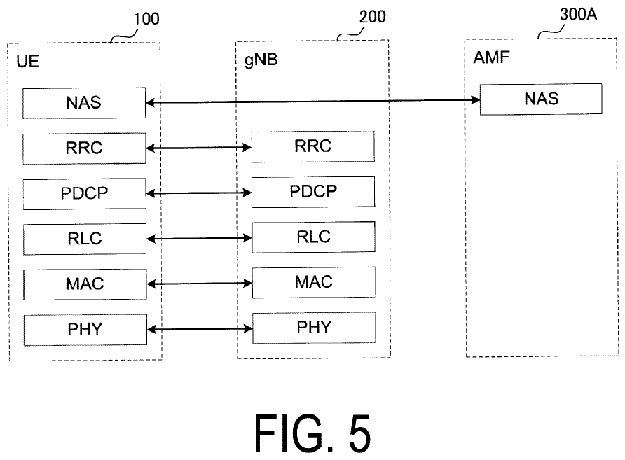

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) between the RRC of the UE 100 and the RRC of the gNB 200 is made, the UE 100 is in an RRC connected state. When no connection (RRC connection) between the RRC of the UE 100 and the RRC of the gNB 200 is made, the UE 100 is in an RRC idle state. When connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of an MBS according to the embodiment will be provided. The MBS is a service enabling data transmission from the NG-RAN 10 to the UE 100 in a broadcast or multicast manner, i.e., a Point To Multipoint (PTM) manner. Assumed use cases (service types) of the MBS include public safety communication, mission critical communication, Vehicle to Everything (V2X) communication, IPv4 or IPv6 multicast delivery, Internet protocol television (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 joining the multicast service (multicast session). An MBS session used for the multicast service is referred to as a multicast session. The multicast service can provide the same content to the group of UEs 100 through a method with higher radio efficiency than the broadcast service.

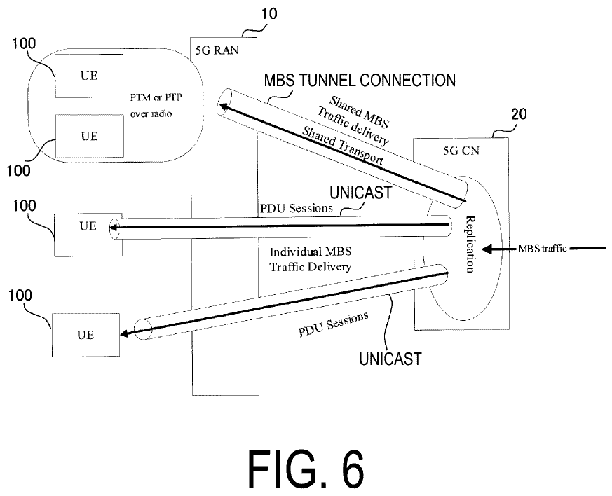

FIG. 6 is a diagram illustrating an overview of MBS traffic delivery according to the embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant data.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those packets to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

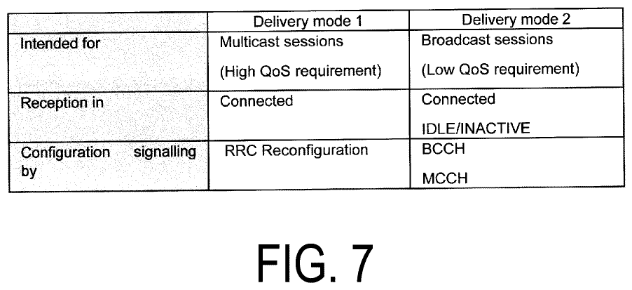

FIG. 7 is a diagram illustrating delivery modes according to the embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

An MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel transmitting MBS data. The MTCH configuration information includes MBS session information (including an MBS session identifier described below) relating to an MBS session and scheduling information of the MBS traffic channel corresponding to the MBS session. The scheduling information of the MBS traffic channel may include discontinuous reception (DRX) configuration of the MBS traffic channel. The discontinuous reception configuration may include at least one parameter selected from the group consisting of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission.

Note that the MBS traffic channel is a type of logical channel and may be referred to as an MTCH. The MBS traffic channel is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. First, the UE 100 receives MCCH configuration information via an SIB (MBS SIB) transmitted from the gNB 200 on the BCCH. Second, the UE 100 receives the MCCH from the gNB 200, based on the MCCH configuration information. On the MCCH, MTCH configuration information is transmitted. Third, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The MBS reception configuration (MTCH configuration information) may include the G-RNTI.

The network can provide different MBS services for different MBS sessions. The MBS session is identified by at least one selected from the group consisting of a Temporary Mobile Group Identity (TMGI), a source-specific IP multicast address (which includes a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

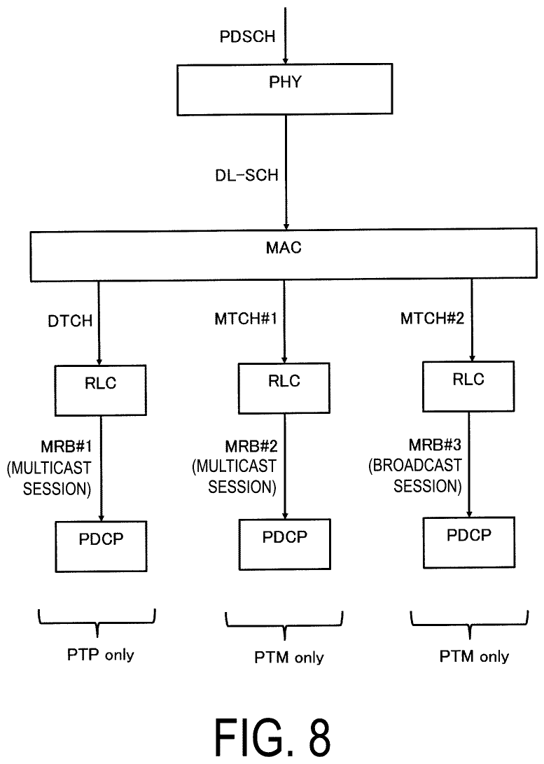

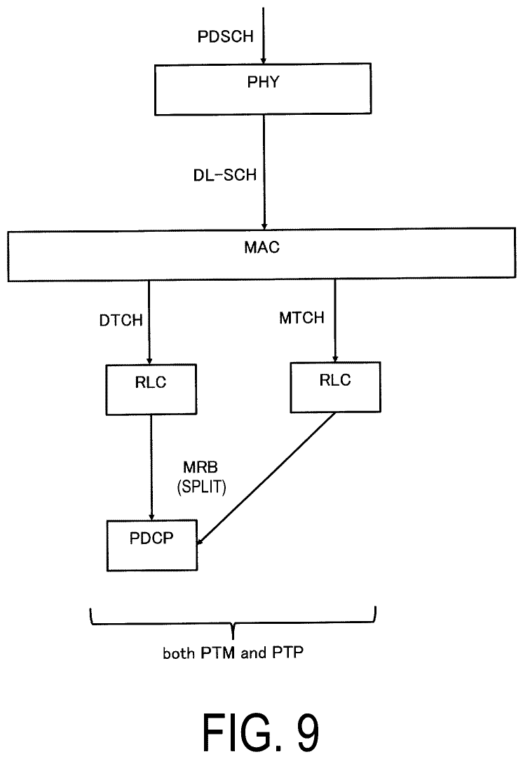

FIG. 8 is a diagram illustrating an example of internal processing related to MBS reception of the UE 100 according to the embodiment. FIG. 9 is a diagram illustrating another example of the internal processing related to the MBS reception of the UE 100 according to the embodiment.

One MBS radio bearer (MRB) is one radio bearer transmitting a multicast session or a broadcast session. That is, a multicast session may be associated with an MRB or a broadcast session may be associated with an MRB.

The MRB and the corresponding logical channel (e.g., MTCH) are configured in the UE 100 from the gNB 200 through RRC signaling. An MRB configuration procedure may be separated from a data radio bearer (DRB) configuration procedure. In the RRC signaling, one MRB can be configured with “PTM only”, “PTP only”, or “both PTM and PTP”. Such a type of MRB may be changed by the RRC signaling.

FIG. 8 illustrates an example in which a multicast session and a dedicated traffic channel (DTCH) are associated with an MRB #1, a multicast session and an MTCH #1 are associated with an MRB #2, and a broadcast session and an MTCH #2 are associated with an MRB #3. That is, the MRB #1 is a PTP only MRB, the MRB #2 is a PTM only MRB, and the MRB #3 is a PTM only MRB. Note that the DTCH is scheduled using a cell RNTI (C-RNTI). The MTCH is scheduled using the G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LCID) included in the header (MAC header) included in the received data.

FIG. 9 illustrates an example in which the DTCH and the MTCH are associated with the MRB associated with the multicast session. Specifically, one MRB is split into two legs, one leg is associated with the DTCH, and the other leg is associated with the MTCH. The two legs are combined at the PDCP layer (PDCP entity). That is, the MRB is an MRB configured with both PTM and PTP. Such an MRB may be referred to as a split MRB.

### Overview of MBS Interest Indication

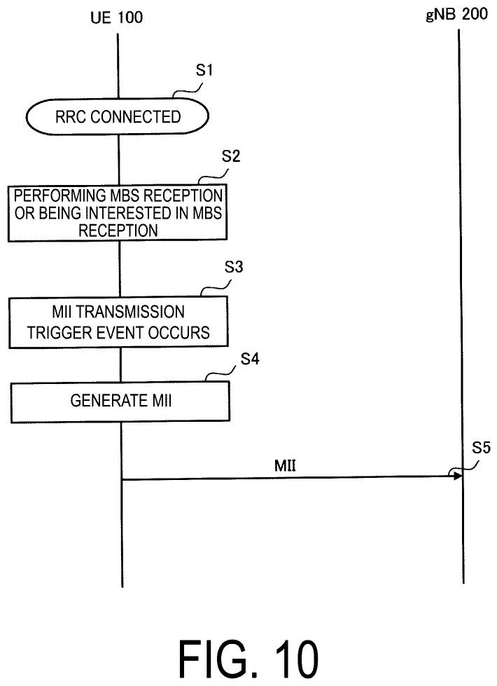

An overview of an MBS Interest Indication (MII) according to the embodiment will be described. FIG. 10 is a diagram for describing the overview of the MII.

The UE 100, which is in the RRC connected state (step S1), is receiving or is interested in receiving an MBS session (step S2).

The UE 100 performs MII transmission processing (i.e., MII procedure) in response to occurrence of an MII transmission trigger (trigger event) (step S3). Specifically, the UE 100 generates an MII (step S4) and transmits the MII to the serving cell (gNB 200) (step S5). The MII may be transmitted via a UE Assistance Information message, which is a type of RRC message. The MII may be transmitted via a newly defined message (MII message).

Examples of a type of the MII transmission trigger (trigger event) include a time of success of connection establishment, a time of entering or leaving a broadcast service area, a time starting or stopping an MBS broadcast session, a time of change in MBS interest, a time of change in priority between MBS broadcast reception and unicast reception, and a time of change to a cell (primary cell) broadcasting an SIB for MBS service continuity.

The MII may include at least one selected from the group consisting of an MBS frequency list, which is a list of MBS frequencies that the UE 100 is receiving or interested in receiving, priority information indicating whether to prioritize reception of all the listed MBS frequencies or reception of a unicast bearer, and a TMGI list, which is a list of MBS sessions that the UE 100 is receiving or interested in receiving.

Note that MII transmission may be limited to only a serving cell broadcasting an SIB for MBS service continuity (hereinafter, referred to as “SIBx1”), that is, a serving cell having a function for MBS service continuity. The UE 100 may transmit the MII to the serving cell only when the serving cell transmits the SIBx1.

### Operation of Mobile Communication System

An operation of the mobile communication system 1 according to the embodiment will be described.

When the UE 100 transmits a large number of MIIs, network congestion may occur. For example, when a large number of UEs 100 transmit MIIs in the same time period or each UE 100 frequently transmits an MII, network congestion may occur.

An assumed scenario in which the large number of UEs 100 transmit the MIIs in the same time period is a scenario in which the large number of UEs 100 transmit the MIIs in the same time period with “start or stop of an MBS broadcast session” as a trigger condition (trigger event). This is because this event is a common event for all the UEs 100 interested in the MBS broadcast session. In consideration of such a scenario, for example, when the type of the trigger condition is “session start”, MII transmission is considered to be dispersed in a time domain and/or frequency domain. For example, when the type of the trigger condition is “session stop”, MII transmission is considered to be turned off.

Examples of an assumed scenario in which each UE 100 frequently transmits the MII include a scenario in which the UE 100 frequently changes its interest according to user preference. The trigger conditions that may cause this problem may be “change in interest” and “change in priority between MBS broadcast reception and unicast reception”. In consideration of such a scenario, it is conceivable to configure a prohibition timer for suppressing frequent MII transmission in the UE 100.

In the mobile communication system 1 according to the embodiment, the gNB 200 transmits, to the UE 100, configuration information for configuring a condition for permitting an MII related to an MBS session that the UE 100 is receiving or interested in receiving to be transmitted to the gNB 200. The UE 100 receives the configuration information from the gNB 200 (serving cell). The UE 100 performs MII transmission processing in response to the condition configured by the configuration information being satisfied.

Such an operation enables the gNB 200 to finely control MII transmission based on the configuration information. Thus, it is possible to suppress the large number of UEs 100 transmitting the MIIs in the same time period or each UE 100 frequently transmitting the MII. As a result, the network congestion caused by the MIIs can be avoided. Note that the MII transmission processing may include transmission of a scheduling request (SR) for MII transmission and/or transmission of a buffer status report (BSR).

Note that the gNB 200 may transmit the configuration information to the UE 100 via an SIB (for example, SIBx1), which is a broadcast message, or an RRC Reconfiguration, which is a UE-dedicated message. The gNB 200 may transmit the configuration information to the UE 100 via an RRC Release, which is a UE-dedicated message for causing the UE 100 to transition to the RRC idle state or RRC inactive state. The UE 100 receives the message including the configuration information from the gNB 200 and stores the received configuration information.

First to third operation examples of the mobile communication system 1 according to the embodiment will be described below. The first to third operation examples may be performed separately and independently. Two of more of the first to third operation examples may be performed in combination.

### (1) FIRST OPERATION EXAMPLE

In the present operation example, the configuration information transmitted from the gNB 200 to the UE 100 includes trigger configuration information for configuring a type of a trigger condition to be applied in the UE 100 among a plurality of types of trigger conditions defined as trigger conditions for triggering MII transmission. The UE 100 triggers MII transmission processing in response to the trigger condition of the type configured by the trigger configuration information among the plurality of types of trigger conditions being satisfied. In this way, the gNB 200 performs control of turning on (enabling)/turning off (disabling) each trigger condition. For example, network congestion can be reduced by turning off MII transmission for a specific trigger condition type in a situation where the load of the gNB 200 increases.

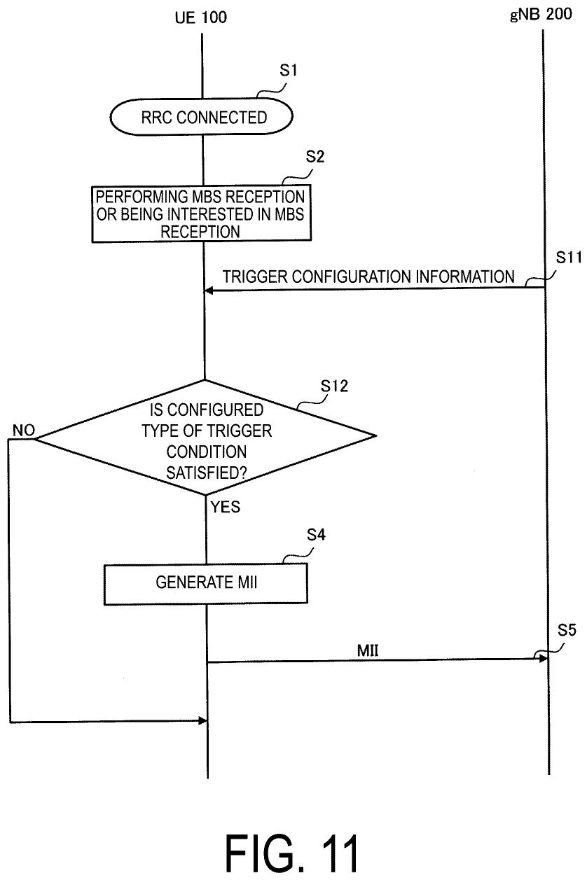

FIG. 11 is a diagram illustrating the first operation example of the mobile communication system 1 according to the embodiment. Here, differences from the operation of FIG. 10 will be mainly described.

As illustrated in FIG. 11, in step S11, the gNB 200 transmits, to the UE 100, configuration information including trigger configuration information for configuring a type of a trigger condition to be applied in the UE 100. The UE 100 receives the configuration information including the trigger configuration information and stores the received configuration information.

In step S12, the UE 100 determines whether the trigger condition of the type configured in step S11 is satisfied.

When it is determined that the trigger condition of the type configured in step S11 has been satisfied (YES in step S12), the UE 100 generates an MII in step S4. In step S5, the UE 100 transmits the MII to the gNB 200. The gNB 200 receives the MII.

On the other hand, when it is determined that the trigger condition of the type configured in step S11 has not been satisfied (NO in step S12), MII transmission processing (steps S4 and S5) is not performed. Note that, in the case of “No” in step S12, the processing may return to step S12 again.

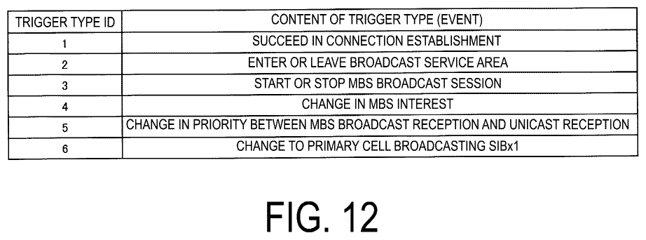

FIG. 12 is a diagram for describing the trigger configuration information according to the present operation example.

As illustrated in FIG. 12, an identifier is assigned to each trigger condition type. FIG. 12 illustrates an example in which the trigger type ID “1” indicates “success of connection establishment”, the trigger type ID “2” indicates “entering or leaving a broadcast service area”, the trigger type ID “3” indicates “start or stop of an MBS broadcast session”, the trigger type ID “4” indicates “change in MBS interest”, the trigger type ID “5” indicates “change in priority between MBS broadcast reception and unicast reception”, and the trigger type ID “6” indicates “change to a primary cell broadcasting an SIBx1”. The correspondence relationships between the trigger type IDs and the contents of the trigger types are not limited to the example illustrated in FIG. 12, and the contents of the trigger types are also not limited to the example illustrated in FIG. 12. For example, different IDs may be assigned to “start of an MBS broadcast session” and “stop of an MBS broadcast session”.

The trigger configuration information may be a list of trigger type IDs indicating types of trigger conditions to be applied in the UE 100. Alternatively, the trigger configuration information may be a list of trigger type IDs indicating types of trigger conditions not to be applied in the UE 100.

The trigger configuration information may be a bit string indicating types of trigger conditions to be applied or not to be applied in the UE 100 by bit positions. For example, a bit string of 6 bits associated with the trigger type IDs “1” to “6” is defined, and a type of a trigger condition to be applied in the UE 100 is represented by True (1) and a type of a trigger condition not to be applied in the UE 100 is represented by False (0).

As a specific example, when only the trigger type IDs “1”, “3”, and “5” are applied, the bit string is “101010”. In this case, the UE 100 performs MII transmission processing only when the trigger conditions of the types indicated by the trigger type IDs “1”, “3”, and “5” are satisfied. That is, the UE 100 does not perform MII transmission processing even when the trigger conditions of the types indicated by the trigger type IDs “2”, “4”, and “6” are satisfied. Note that the trigger type ID is numbered from “1” in this example but may be numbered from “0”. In the example of the bit string “101010”, the Most Significant Bit (MSB) corresponds to the trigger type ID “1” and the Least Significant Bit (LSB) corresponds to the trigger type ID “6”. However, the correspondence relationship may be reversed. That is, the bit string is “010101”, the LSB corresponds to the trigger type ID “1”, and the MSB corresponds to the trigger type ID “6”.

The trigger configuration information may include a combination ID indicating a combination of trigger condition types to be applied or not to be applied in the UE 100. For example, a table in which an ID is defined for each possible combination of trigger condition types to be applied or not to be applied in the UE 100 may be shared between the UE 100 and the gNB 200, and the trigger condition types to be applied or not to be applied in the UE 100 may be specified by such a combination ID.

### (2) SECOND OPERTATION EXAMPLE

In the present operation example, the configuration information transmitted from the gNB 200 to the UE 100 includes prohibition time configuration information (so-called prohibition timer value) for configuring a prohibition time from when an n-th (n≥1) MII is transmitted to when an (n+1)-th MII can be transmitted. The UE 100 transmits a current MII in response to the prohibition time configured by the prohibition time configuration information elapsing (that is, expiration of the prohibition timer) from when a previous MII has been transmitted. This can suppress frequent MII transmission by the UE 100. Specifically, since MII transmission is prohibited during the prohibition time (i.e., during the running of the prohibition timer), it is possible to perform control so that even the UE 100 frequently changing MBS interest does not perform frequent MII transmission.

The prohibition timer may be associated with only a specific trigger condition. That is, the UE 100 may manage the prohibition timer for each trigger condition. In this case, the configuration information transmitted from the gNB 200 to the UE 100 may further include trigger type information associated with the prohibition time configuration information. The trigger type information is information indicating a type of a trigger condition to which the prohibition time is to be applied among a plurality of types of trigger conditions defined as trigger conditions for triggering MII transmission.

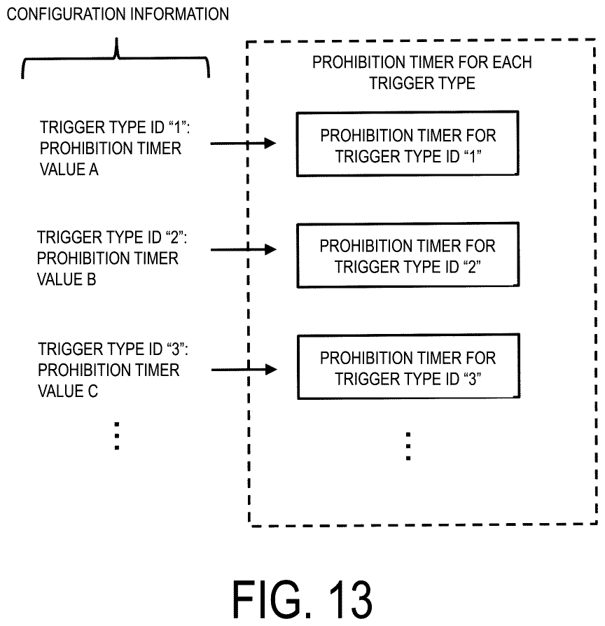

For example, as illustrated in FIG. 13, the configuration information transmitted from the gNB 200 to the UE 100 includes a plurality of sets of trigger type information (trigger type IDs) and prohibition time configuration information (prohibition timer values). FIG. 13 illustrates an example in which the prohibition timer value “A” is configured for the trigger type ID “1”, the prohibition timer value “B” is configured for the trigger type ID “2”, and the prohibition timer value “C” is configured for the trigger type ID “3”. However, the prohibition timer values may not be configured for all the trigger types and may be configured only for some of the trigger types. Alternatively, the prohibition timer value may not be independently (individually) configured for each trigger type ID, and a common prohibition timer value may be configured for a plurality of trigger type IDs.

When the trigger conditions are associated with the prohibition timer values, the UE 100 manages the prohibition timers for the respective trigger conditions. For example, after transmitting a previous MII in response to a trigger condition of a type indicated by the trigger type information (hereinafter referred to as a “specific trigger condition”) being satisfied, the UE 100 transmits a current MII in response to the prohibition time associated with the specific trigger condition (i.e., expiration of the prohibition timer) elapsing and the specific trigger condition being satisfied.

However, the UE 100 may manage a common prohibition timer for all the trigger types without associating the trigger conditions and the prohibition timer values. In this case, regardless of the trigger conditions, the UE 100 transmits the current MII in response to the prohibition time configured by the prohibition time configuration information elapsing (i.e., expiration of the prohibition timer) after transmitting the previous MII.

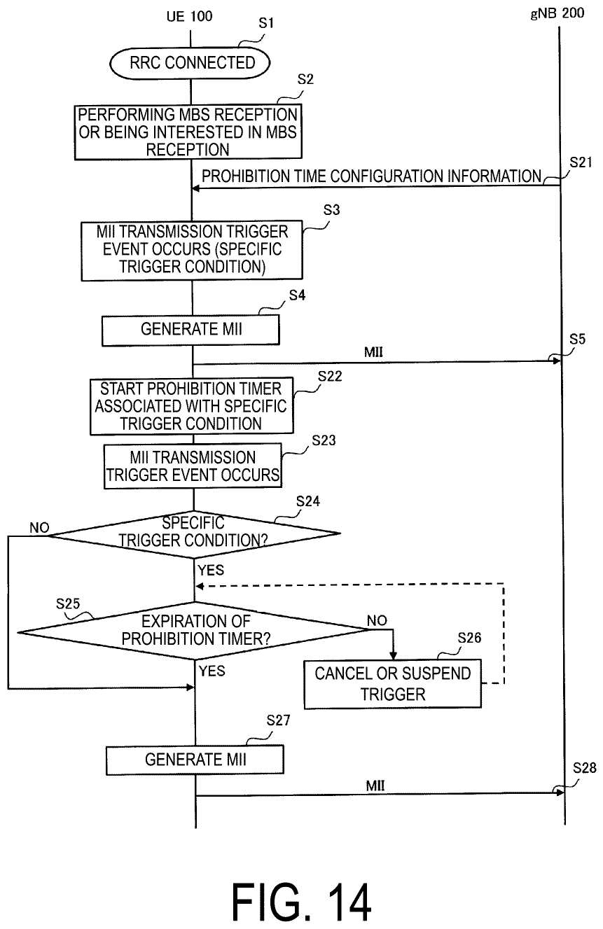

FIG. 14 is a diagram illustrating the second operation example of the mobile communication system 1 according to the embodiment. Here, differences from the operation of FIG. 10 will be mainly described. A case of associating the trigger conditions and the timer values will be described as an example.

In step S21, the gNB 200 transmits, to the UE 100, configuration information including prohibition time configuration information (prohibition timer values) and trigger type information. The UE 100 receives the configuration information including the prohibition time configuration information and the trigger type information and stores the received configuration information.

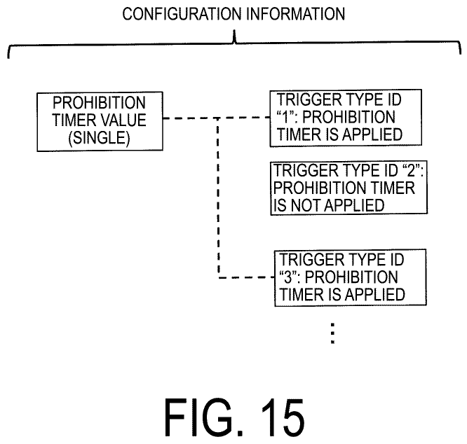

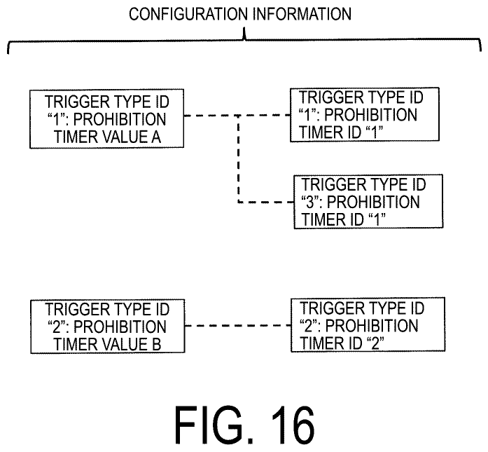

Here, one or more prohibition timer values may be configured for a plurality of trigger conditions. For example, when a common prohibition timer is used, an identifier indicating application or non-application of a timer may be associated with each trigger condition as illustrated in FIG. 15, and a single value may be configured as the prohibition timer value. Alternatively, as illustrated in FIG. 16, each trigger condition may be associated with an identifier (prohibition timer ID) indicating which prohibition timer value is to be assigned, and each of a plurality of prohibition timer values may be associated with the prohibition timer ID.

In step S3, an MII transmission trigger event occurs in the UE 100. A type of the trigger occurring here is referred to as a “specific trigger condition”. The specific trigger condition may be, for example, “change in MBS interest”.

In step S4, the UE 100 generates an MII.

In step S5, the UE 100 transmits the MII to the serving cell (gNB 200). The gNB 200 receives the MII from the UE 100.

In step S22, when the specific trigger condition is associated with a prohibition timer value, the UE 100 starts a prohibition timer in which the prohibition timer value associated with the specific trigger condition is set.

In step S23, an MII transmission trigger event occurs in the UE 100.

In step S24, the UE 100 determines whether the transmission trigger event that has occurred in step S23 corresponds to the specific trigger condition (e.g., “change in MBS interest”). When the transmission trigger event that has occurred in step S23 does not correspond to the specific trigger condition (NO in step S24), for example, when the transmission trigger event is “start of a broadcast session”, the UE 100 performs MII transmission processing (steps S27 and S28).

On the other hand, when the transmission trigger event that has occurred in step S23 corresponds to the specific trigger condition (YES in step S24), the UE 100 determines, in step S25, whether or not the prohibition timer associated with the specific trigger condition has expired.

When the prohibition timer has not expired, i.e., when the prohibition timer is running (NO in step S25), the UE 100 ignores the transmission trigger event that has occurred in step S23 and does not perform MII transmission processing in step S26. Alternatively, in step S26, the UE 100 suspends MII transmission corresponding to the transmission trigger event that has occurred in step S23 until the prohibition timer expires.

On the other hand, when the prohibition timer has expired (YES in step S25), the UE 100 performs, in steps S27 and S28, MII transmission processing corresponding to the transmission trigger event that has occurred in step S23. Note that when there is a suspended trigger condition at the expiration of the timer, the UE 100 may transmit the MII under this trigger condition.

In the present operation example, when the UE 100 has transitioned to the RRC idle state or the RRC inactive state, the UE 100 may stop the prohibition timer. Whether to perform such stop or continue the timer operation may be configured in the UE 100 by the gNB 200 (for each trigger condition).

### (3) THIRD OPERATION EXAMPLE

In the present operation example, the configuration information includes dispersion information for dispersing transmission of a plurality of MIIs by a plurality of UEs 100 in the time domain and/or frequency domain. The UEs 100 transmit the MIIs at timings and/or frequencies determined based on the dispersion information. By dispersing the transmission of the plurality of MIIs by the plurality of UEs 100 in the time domain and/or frequency domain, it is possible to suppress network congestion due to the MIIs.

The dispersion information may be associated with only a specific trigger condition. That is, each UE 100 may manage MII transmission control according to the dispersion information for each trigger condition. In this case, the configuration information transmitted from the gNB 200 to the UE 100 may further include trigger type information associated with the dispersion information. The UE 100 may transmit an MII at a timing and/or frequency determined based on the dispersion information in response to a trigger condition of a type indicated by the trigger type information being satisfied.

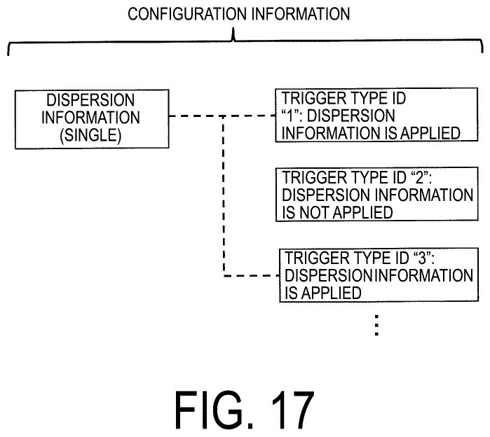

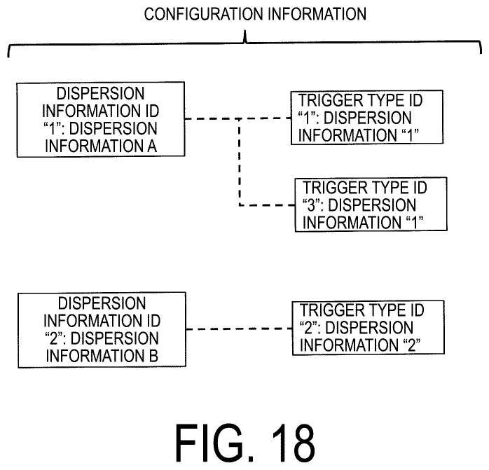

As a method of associating the trigger conditions and the dispersion information, a method same as and/or similar to that of the above-described second operation example can be used. For example, when common dispersion information is used, an identifier indicating application/non-application of the dispersion information may be associated with each trigger condition, and a single value may be configured as the dispersion information as illustrated in FIG. 17. Alternatively, as illustrated in FIG. 18, each trigger condition may be associated with an identifier (dispersion information ID) indicating which dispersion information is to be assigned, and each of the plurality of pieces of dispersion information may be associated with the dispersion information ID.

However, the UE 100 may apply common dispersion information to all the trigger types without associating the trigger conditions with the dispersion information. In this case, the UE 100 determines, for each MII transmission, a timing and/or frequency at which the MII is to be transmitted based on the dispersion information, regardless of the trigger conditions.

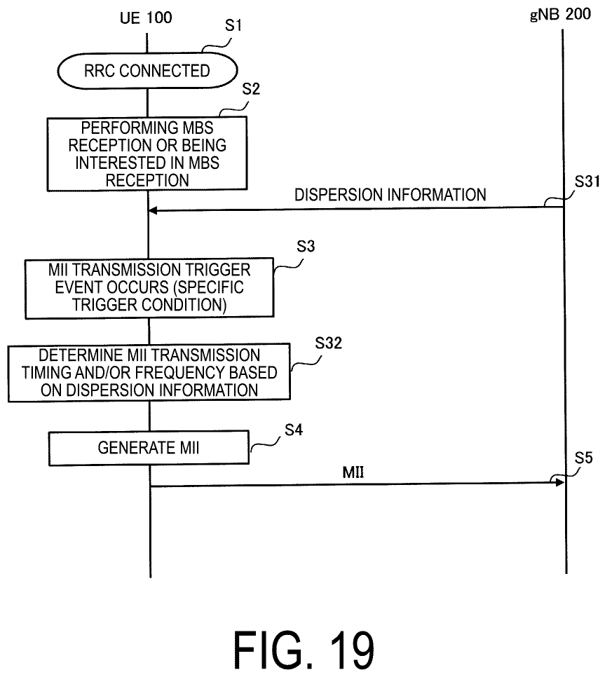

FIG. 19 is a diagram illustrating the third operation example of the mobile communication system 1 according to the embodiment. Here, differences from the operation of FIG. 10 will be mainly described. A case of associating the trigger conditions and the dispersion information will be described as an example.

In step S31, the gNB 200 transmits, to the UE 100, configuration information including dispersion information and trigger type information. The UE 100 receives the configuration information including the dispersion information and the trigger type information and stores the received configuration information.

In step S3, an MII transmission trigger event occurs in the UE 100. A type of the trigger occurring here is referred to as a “specific trigger condition”.

In step S32, when the specific trigger condition is associated with dispersion information, the UE 100 determines a timing and/or frequency for transmitting an MII based on the dispersion information associated with the specific trigger condition.

In step S4, the UE 100 generates an MII. Note that step S4 may be performed before step S32.

In step S5, the UE 100 transmits, to the serving cell (gNB 200), the MII at the timing and frequency determined in step S32. The gNB 200 receives the MII from the UE 100.

### (3.1) Example of Dispersion in Frequency Domain

The dispersion information may include cell information for configuring a cell in which the UE 100 transmits an MII. This enables dispersion of MII transmission in the frequency domain. For example, the gNB 200 instructs the UE 100 configured with carrier aggregation (CA) to transmit an MII in a primary cell (PCell) or a secondary cell (SCell) based on the dispersion information (cell information). The UE 100 transmits the MII to the configured cell.

The cell information may be a cell ID indicating a cell in which the UE 100 transmits the MII. When a serial number (configuration order) is assigned to an SCell, the cell information may be an SCell number indicating an SCell in which the UE 100 transmits the MII. The cell information may be simply an indication of any SCell without specifying a specific cell. Where there is no indication, the UE 100 may determine to transmit the MII in the PCell. Note that the cell information may be frequency information (for example, ARFCN) instead of the cell ID or may be a combination of the cell ID and the frequency information.

Note that when CA is configured, a rule that MII transmission is always permitted only in the SCell may be defined. In this case, the UE 100 configured with the CA does not transmit the MII in the PCell but transmits the MII in the SCell. On the premise that such a rule exists, CA configuration information for configuring the CA in the UE 100 by the gNB 200 can be regarded as a kind of dispersion information.

### (3.2) Example of Dispersion in Time Domain

The dispersion information may include timing control information for controlling a timing at which the UE 100 transmits an MII. This enables dispersion of MII transmission in the time domain. The timing control information may be information for configuring turning-on (enabling)/turning-off (disabling) of processing of dispersing MII transmission timings of the UEs in the time domain, or may include a parameter (for example, a threshold value or the like) used for the processing.

### (3.2.1) First Pattern of Dispersion in Time Domain

The UE 100 may determine a timing for transmitting an MII based on the timing control information and an identifier unique to the UE 100 (hereinafter referred to as “UE-ID”). Alternatively, the UE 100 may determine a timing for transmitting an MII based on the timing control information and a random number generated by the UE 100. This enables timings at which the plurality of UEs 100 transmit a plurality of MIIs to be more reliably dispersed in the time domain.

For example, the UE 100 is permitted to transmit the MII in a frame satisfying the following equation:

[UE-ID]mod[Frame number]=0. Here,

[UE-ID] may be as follows:

[UE-ID]=[5G-S-TMSI]mod[Frame upper limit value]. [Frame upper limit value] may be as follows:
[Frame upper limit value]=10 (in the case of a subframe) or 1024 (in the case of a radio frame).

Alternatively, the UE 100 configures a threshold value (from 0 to 1), generates a random number, and is permitted to perform transmission when the random number is equal to or larger than (or equal to or smaller than) the threshold value. However, the total number of the UEs 100 transmitting the MIIs decreases each time of attempt. When the probability that the MII can be transmitted is constant, the number of the UEs 100 transmitting the MIIs decreases each time of attempt, and thus the transmission delay of the MII may increase more than necessary. Thus, control may be performed so that the probability that the MII can be transmitted increases as the number of times of attempts increases. Specifically, scaling based on a threshold value may be performed so that the number of the UEs 100 transmitting the MIIs is kept constant each time of attempt. Specifically,

[Threshold value to be applied]=[Initial threshold value]+[Scaling value]×([Number of times of attempts]−1).

For example, when [Initial threshold value] is 0.5, [Scaling value] is 0.1, and the number of times of attempts is 3, [Threshold value to be applied] is 0.5+0.1×(3−1), which is 0.7. [Initial threshold value] means a threshold value configured by the gNB 200.

Alternatively, [Threshold value to be applied] may be as follows:

[Threshold value to be applied]=[Threshold value previously applied]+[Scaling value].

Only at the first attempt, [Threshold value previously applied] may be as follows:

[Threshold value previously applied]=[Initial threshold value]−[Scaling value].

### (3.2.2) Second Pattern of Dispersion in Time Domain

The UE 100 may determine a timing for transmitting an MII based on the timing control information and an MBS session start timing known by the UE 100. The UE 100 can know the MBS session start timing based on, for example, User Service Description (USD), which is upper-layer information. Specifically, it is assumed that the USD includes information about the session start timing (time or the like).

First, the UE 100 reads, from the USD, a TMGI of interest and a session start timing of the TMGI.

Second, the UE 100 transmits an MII at an appropriate timing before the session start timing.

Alternatively, the gNB 200 may transmit, to the UE 100, timing control information indicating how early the MII starts to be transmitted before the session start timing. Such timing control information is information indicating how early the MII starts to be transmitted, and may be represented by, for example, a radio frame, subframe, or hyper frame. Such timing control information may be represented by time information (second, minute, hour, etc.).

According to the indication, the UE 100 may determine, by the following method, whether it is possible to transmit the MII. For example, the UE 100 is permitted to transmit the MII when the elapsed time satisfies the following equation:

[UE-ID]mod[Elapsed time]=0. [Elapsed time] may be represented by, for example, a second, minute, or radio frame.

Note that [UE-ID] may be as follows:

[UE-ID]=[5G-S-TMSI]mod[Information indicating how early].

Instead of such a method of using the UE-ID, the above-described method of dispersion in the time domain may be used. In this case, the method of dispersion in the time domain from a time point indicated by [how early] is applied. The gNB 200 may notify the UE 100 of timing information indicating a timing for permitting MII transmission. The timing information may be a pattern of radio frames or subframes and/or a reference point (e.g., a start radio frame). The timing information may be associated with the trigger type.

### Variation of Operation of Mobile Communication System

A variation of the operation of the mobile communication system according to the embodiment will be described.

When carrier aggregation (CA) is configured in the UE 100, an MBS frequency that the UE 100 is receiving, interested in receiving, or capable of receiving may change according to the situation of the CA. In this case, when there is a change from an MBS frequency list of which the gNB 200 has been notified via a previous MII, it is conceivable to notify the gNB 200 of a latest MBS frequency of interest.

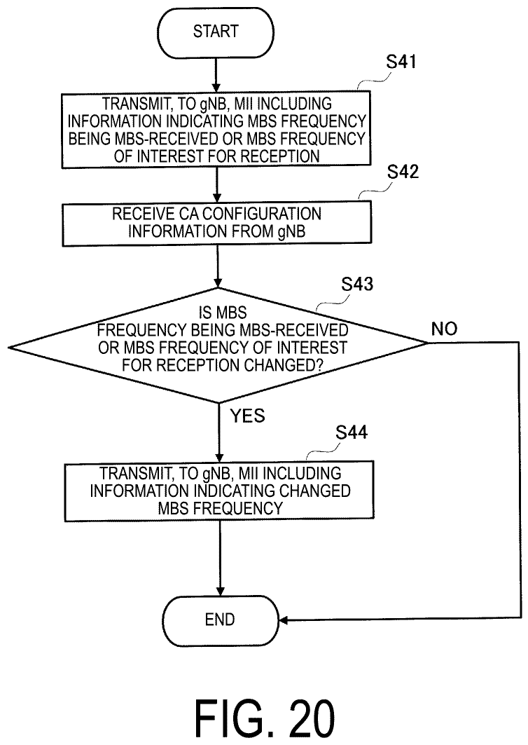

FIG. 20 is a diagram illustrating an operation of the UE 100 according to the present variation.

In step S41, the UE 100 transmits, to the gNB 200, a first MII including information indicating, among a combination of a plurality of frequencies that the UE 100 can simultaneously receive, one or more MBS frequencies that the UE 100 is receiving or is interested in receiving. Specifically, the UE 100 transmits a first MII including an MBS frequency list of MBS frequencies of interest that can be simultaneously received.

In step S42, the UE 100 receives, from the gNB 200, CA configuration information about configuration of carrier aggregation (CA). The CA configuration information is transmitted from the gNB 200 to the UE 100 via, for example, an RRC Reconfiguration. The CA configuration information is information about configuration, configuration change, or configuration cancellation of the CA.

When the combination is changed according to the CA configuration information and the one or more MBS frequencies that the UE 100 is receiving or is interested in receiving are changed (YES in step S43), the UE 100 transmits a second MII including information indicating changed MBS frequencies to the gNB 200 in step S44. Specifically, the UE 100 re-evaluates the frequencies of interest and checks whether there is a change in the frequencies that can be received simultaneously due to the current CA configuration. When there is a change, the UE 100 specifies frequencies of interest that can be simultaneously received, sets the specified frequencies in the frequency information of the MII, and transmits the MII.

In this way, at the time of the CA configuration (change), the UE 100 transmits the MII when there is a change in the information about the frequencies of interest that can be received simultaneously, which has been reported by the previous MII. This will be described with reference to a specific example. First, it is assumed that the UE 100 has already notified the gNB 200 via an MII that an MBS of interest is provided at frequencies F4 and F5 and that the UE 100 is interested in the frequency F5. It is assumed that the UE 100 supports the following two combinations (band combinations) as combinations of frequencies that can be simultaneously received.

Band combination #1: F1, F2, F3, F4

Band combination #2: F1, F2, F4, F5

It is assumed that CA of F1 and F2 is configured in the UE 100. In this case, both Band combination #1 and Band combination #2 can be used.

Third, an SCell of F3 is added in the UE 100 due to the CA configuration. As a result, the UE 100 can use only Band combination #1. Fourth, the frequency in which the UE 100 is interested changes from F5 to F4. Fifth, the UE 100 determines that F4 is to be reported via an MII and reports F4 to the gNB 200 via the MII.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiment and example described above, an example in which the base station is an NR base station (i.e., a gNB) has been described; however, the base station may be an LTE base station (i.e., an eNB) or a 6G base station. The base station may be a relay node such as an Integrated Access and Backhaul (IAB) node. The base station may be a DU of the IAB node. The UE 100 may be a Mobile Termination (MT) of the IAB node.

A program causing a computer to execute each processing performed by the UE 100 or the gNB 200 may be provided. The program may be recorded in a computer readable medium. Use of the computer readable medium enables the program to be installed on the computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be configured as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain/acquire information from stored information, may mean to obtain/acquire information from information received from another node, or may mean to obtain/acquire information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiment has been described above in detail with reference to the drawings, but specific configurations are not limited to those described above, and various design variation can be made without departing from the gist of the present disclosure.

### SUPPLEMENTARY NOTE 1

### 1. Introduction

The revised work item for NR Multicast and Broadcast Services (MBS) has been approved in RAN #88. In RAN2 #116e, there has been significant progress in the details of the MBS interest indication (MII).

In this supplementary note, the remaining problems related to the MBS interest indication are considered.

### 2. Discussion

### 2.1. Definition of Message

The currently running CR of TS38.331 incorporates the following matters that require further considerations.

A further study is necessary regarding whether an MII (MBMS interest indication) is reported via UE Assistance Information or a new RRC message and whether MII information uses a separate IE and is included directly in an RRC message structure.

In LTE, the MBMS interest indication (MII) is separated from the UE Assistance Information (UAI). This is because the preconditions of obtaining an SIB15 in the MII and an RRC Connection Reconfiguration in the UAI are different. On the other hand, an In-device Coexistence Indication (IDC), which is a separate message in LTE, is integrated into the UAI in NR. This is considered feasible in LTE (and NR) because the preconditions for the IDC and the UAI are the same, i.e., RRC Connection Reconfiguration.

Observation 1: Whether the MBS interest indication can be integrated with the UE Assistance Information depends on whether the preconditions match between the two messages.

In the NR MBS, neighboring frequency information in an SIB is needed for generation of an MBS interest indication message including the above IE. When the UE can obtain the SIB from the serving cell, transmission of the MBS interest indication is permitted, which is already understood under the condition that “the SIBx1 is broadcast from the PCell” in the approved CR, in a manner same as and/or similar to the LTE eMBMS. Thus, it does not match an RRC Reconfiguration, which is a precondition of the UAI. Thus, the MBS interest indication needs to be a separate message from the UAI, like the LTE eMBMS.

Proposal 1: RAN2 needs to agree to define the MBS interest indication as a new message, i.e., separately from the UAI.

Proposal 2: RAN2 needs to agree that transmission of the MBS interest indication is permitted when the UE can acquire an MBS-specific SIB (i.e., SIBx1) from the serving cell (i.e., as a precondition).

### 2.2. Other Triggers and Network Control

The following matters that require further considerations are incorporated into the currently running CR.

Other triggers and network control need to be further studied.

RAN2 #116e has agreed on various triggers for the MBS interest indication. It is confirmed that the UE can start an MII procedure at a time of success of connection establishment, a time entering or leaving a broadcast service area, a time of starting or stopping an MBS broadcast session, a time of change in interest, a time of change in priority order between MBS broadcast reception and unicast reception, or a time of change to a PCell broadcasting an SIBx1. Other triggers and network control need to be further studied.

For an additional trigger, it is considered to be necessary to transmit the MBS interest indication at a time of change in a frequency list. RAN2 #116e has agreed on a detailed operation of a method of configuring a frequency of interest as follows.

During the MII, the UE needs to report only a set of MBS frequencies that the UE can simultaneously receive. That is, the UE supports at least one band combination and can receive an indicated set of frequencies.

The UE does not consider the currently configured serving frequency when evaluating frequencies that can be simultaneously received for reporting using the MII. That is, only the MBS frequency of interest for reception is considered, regardless of whether it is possible to perform reception together with the current serving cell.

According to the above agreement, when carrier aggregation configuration is updated (such as addition or deletion of the SCell), it may affect a bandwidth combination in which the UE can currently operate and thus a frequency list may be changed. In this case, when the list is different from the frequency list that has been reported in the previous MBS interest indication, it may be necessary to report the latest frequency of interest to the serving cell. Thus, RAN2 needs to consider whether to transmit the MBS interest indication when the frequencies of the serving cell and the non-serving cell are changed due to configuration change of the serving cell.

Proposal 3: RAN2 needs to consider whether to transmit the MBS interest indication when the frequency of interest of the UE is changed due to configuration change of the serving cell.

Network control is certainly useful if it is possible to manage transmission of MBS interest indications from a large number of UEs in order to avoid network congestion. Problems that cause resource overload include a “spike” in the number of MBS interest indications and “frequent” MBS interest indications.

Observation 2: Network congestion may occur due to a spike in the number of MBS interest indications from a large number of UEs or frequent MBS interest indications from a certain UE.

When a large number of UEs simultaneously transmit MBS interest indications, a spike in transmission occurs. Since this is a common event for all UEs interested in an MBS broadcast session, a possible trigger for causing this problem may be “start or stop an MBS broadcast session”. In particular, when the session is stopped, the gNB already knows that the MBS broadcast session has been stopped by the CN and thus can determine that the UE has lost interest in this TMGI without the MBS interest indication. In view of these scenarios, conceivable network control is to spread the MBS interest indications in a time domain and/or frequency domain (e.g., session start) or to turn on/off the MBS interest indications during this event (e.g., session stop).

Frequent transmission occurs when the UE frequently changes interest due to user preference, etc. Conceivable triggers for causing this problem include “change in interest” and “change in priority between MBS broadcast reception and unicast reception”. Conceivable network control includes configuring a prohibition timer in the UE.

Other triggers, i.e., “success of connection establishment”, “entering or leaving a broadcast service area”, and “change to a PCell broadcasting an SIBx1” are considered to cause no major problems since these triggers are sufficiently made random (in terms of time) or already controlled by the network.

In light of the above discussion, it has been confirmed that different triggers may require different control methods, i.e., spreading, turning on/off, and prohibition timer, and yet other triggers may not require any enhancement. Thus, RAN2 needs to discuss whether to consider network control, and if so, which trigger requires what kind of network control.

Proposal 4: RAN2 needs to discuss network control for suppressing a spike in transmission of MBS interest indications and frequent transmission of MBS interest indications by the UE.

Proposal 5: RAN2 needs to discuss whether to apply different network control methods to different triggers of MBS interest indications.

### 2.3. Early Notification for Improving BWP Switching Operation

This consideration is incorporated into the currently running CR based on the RAN2 agreement that “the MBS interest indication is transmitted after security activation (it can still be discussed whether additional optimization is needed for a better BWP switching operation)”.

Whether additional optimization is needed for improvement of a BWP switching operation needs to be further studied.

Whether further optimization is needed for a better BWP switching operation needs to be further studied.

A problem regarding service continuity occurs when the UE transitions to the connected state. Specifically, when the serving cell configures a dedicated BWP inconsistent with a CFR in the UE, the UE cannot continuously receive a broadcast session. Although such configuration can be avoided after the MBS interest indication, a problem arises due to configuration performed before the MBS interest indication, i.e., before AS security activation.

It is pointed out that the UE in the inactive state can configure a dedicated BWP via Msg4 (RRC Resume), and it is proposed to provide a 1-bit indication in Msg3 to notify the serving cell that the UE is receiving an MBS broadcast session. The serving cell has a UE context for the UE in the inactive state and the UE context includes a previously reported MBS interest indication. Although this is not the latest interest information, the serving cell is expected to predict whether the UE transitioning from the inactive state to the connected state is receiving a broadcast session. Thus, it is not important to extend Msg3 in consideration of a limited message size.

It is proposed to introduce an early “broadcast reception” indication of Msg5, which is information for configuring a dedicated BWP by the serving cell via the next RRC Reconfiguration. This solution is a simple extension but still useful.

According to the LS from SA3, they are only concerned about reporting a TMGI list before AS security activation. It is explicitly mentioned that other information (frequency list and priority order information) can be reported before AS security activation. Thus, the UE is considered to be able to transmit the early MBS interest indication. The early MBS interest indication is transmitted together with Msg5 and includes the full contents other than the TMGI list, i.e., the frequency list and the priority order information instead of the above 1-bit indication. When the gNB receives the early MBS interest indication via Msg5, it can be determined whether this UE is receiving a broadcast session because the MBS interest indication is for the second delivery mode. Even if the TMGI in which the UE is interested is still unknown, the full contents may be useful for the gNB to determine appropriate configuration (e.g., SCell configuration) for different frequencies. Since these contents are finally reported after AS security activation, there is no signaling overhead if these contents are reported in the early MBS interest indication.

It is worth considering whether additional information is needed for the early MBS interest indication. For example, the UE reports a CFR receiving an MBS broadcast session of interest in the early MBS interest indication. For example, the gNB may use CFR information to determine an appropriate dedicated BWP such that such a CFR is part of the dedicated BWP. As another example, the UE reports a Cell ID in which the MBS broadcast session of interest is provided using the early MBS interest indication.

Proposal 6: RAN2 needs to study whether to transmit the early MBS interest indication together with Msg5 including the full contents other than a TMGI list, i.e., a frequency list and priority information.

Proposal 7: RAN2 needs to further discuss whether it is useful to report additional information in the early MBS interest indication, such as a CFR and a cell ID of interest.

### 2.4. MBS Interest Indication of Multicast Session

RAN2 currently assumes that the MBS interest indication is supported in broadcast sessions and not in multicast sessions. RAN2 #115e has agreed on the basic contents of the MBS interest indication, i.e., an MBS frequency list, priority, and TMGI list.

In a multicast session, it is commonly understood that the core network notifies the gNB of the interest of the UE because a session join procedure is in an upper layer. The interest of the UE is considered to apply to MBS services. The gNB may know the MBS frequency and the cell providing the MBS service of interest of the UE. However, the priority order between MBS reception and unicast, which is purely AS-related information, may not be provided from the core network. That is, it is strange for the UE to convey priority order information to the core network during the session join procedure.

Observation 3: For a multicast session, the core network provides the gNB with an MBS service of interest of the UE, and the gNB may know the MBS frequency/cell, but the core network and the gNB may not know AS priority of the UE between MBS and unicast.

Priority information, in a manner same as and/or similar to the LTE eMBMS, is also useful for the gNB, such as scheduling and handover determination, and may also be relevant to service continuity. Thus, the UE needs to notify the gNB of the priority information also for multicast sessions. In this sense, RAN2 needs to agree that the MBS interest indication needs to be supported for multicast service/first delivery mode.

Proposal 8: RAN2 needs to agree that the MBS interest indication is also supported for multicast session/first delivery mode, at least for the UE to notify the gNB of the priority order between MBS reception and unicast.

### SUPPLEMENTARY NOTE 2

Features relating to the embodiment described above are described below.

(1)

A communication method performed by a user equipment in a mobile communication system providing a multicast and broadcast service (MBS), the communication method including: receiving, from a base station, configuration information configuring a condition under which the user equipment is permitted to transmit, to the base station, an MBS interest indication regarding an MBS session that the user equipment is receiving or is interested in receiving; and performing transmission processing of the MBS interest indication in response to the condition configured by the configuration information being satisfied.

(2)

The communication method according to (1) described above, wherein the performing of the transmission processing includes not performing the transmission processing when the condition configured by the configuration information is not satisfied and performing the transmission processing in response to the condition configured by the configuration information being satisfied.

(3)

The communication method according to (1) or (2) described above, wherein the configuration information includes trigger configuration information configuring a type of a trigger condition to be applied in the user equipment among a plurality of types of trigger conditions defined as trigger conditions under which transmission of the MBS interest indication is triggered, and the performing of the transmission processing includes triggering the transmission processing in response to the trigger condition of the type configured by the trigger configuration information among the plurality of types of trigger conditions being satisfied.

(4)

The communication method according to any one of (1) to (3) described above, wherein the configuration information includes prohibition time configuration information configuring a prohibition time from when an n-th (n≥1) MBS interest indication is transmitted to when an (n+1)-th MBS interest indication is capable of being transmitted, and the performing of the transmission processing includes transmitting a current MBS interest indication in response to the prohibition time configured by the prohibition time configuration information elapsing after transmitting a previous MBS interest indication.

(5)

The communication method according to (4) described above, wherein the configuration information further includes trigger type information associated with the prohibition time configuration information, and the trigger type information is information indicating a type of a trigger condition to which the prohibition time is to be applied among a plurality of types of trigger conditions defined as trigger conditions under which transmission of the MBS interest indication is triggered.

(6)

The communication method according to (5) described above, wherein the performing of the transmission processing includes transmitting the previous MBS interest indication in response to the trigger condition of the type indicated by the trigger type information being satisfied and then transmitting the current MBS interest indication in response to the prohibition time configured by the prohibition time configuration information elapsing and the trigger condition of the type indicated by the trigger type information being satisfied.

(7)

The communication method according to any one of (1) to (6) described above, wherein the configuration information includes dispersion information configured to disperse, in a time domain and/or a frequency domain, transmission of a plurality of MBS interest indications by a plurality of user equipments including the user equipment, and the performing of the transmission processing includes transmitting the MBS interest indication at a timing and/or a frequency determined based on the dispersion information.

(8)

The communication method according to (7) described above, wherein the configuration information further includes trigger type information associated with the dispersion information, and the performing of the transmission processing includes transmitting the MBS interest indication at the timing and/or the frequency determined based on the dispersion information in response to the trigger condition of the type indicated by the trigger type information being satisfied.

(9)

The communication method according to (7) or (8) described above, wherein the dispersion information includes cell information configuring a cell in which the user equipment transmits the MBS interest indication.

(10)

The communication method according to (7) or (8) described above, wherein the dispersion information includes timing control information configured to control a timing at which the user equipment transmits the MBS interest indication.

(11)

The communication method according to (10) described above, wherein the performing of the transmission processing includes determining the timing of transmitting the MBS interest indication based on the timing control information and an identifier unique to the user equipment.

(12)

The communication method according to (10) described above, wherein the performing of the transmission processing includes determining the timing of transmitting the MBS interest indication based on the timing control information and a random number generated by the user equipment.

(13)

The communication method according to (10) described above, wherein the performing of the transmission processing includes determining the timing of transmitting the MBS interest indication based on the timing control information and an MBS session start timing known by the user equipment.

(14)

A communication method performed by a user equipment in a mobile communication system for providing a multicast and broadcast service (MBS), the communication method including: transmitting, to a base station, a first MBS interest indication including information indicating, among a combination of a plurality of frequencies that the user equipment is capable of simultaneously receiving, one or more MBS frequencies that the user equipment is receiving or is interested in receiving; receiving, from the base station, carrier aggregation (CA) configuration information regarding a CA configuration; and transmitting a second MBS interest indication to the base station when the combination is changed according to the CA configuration information and the one or more MBS frequencies that the user equipment is receiving or interested in receiving are changed, the second MBS interest indication including information indicating a changed MBS frequency.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method performed by a user equipment in a mobile communication system for providing a multicast and broadcast service (MBS), the communication method comprising:
receiving, from a network node, a broadcast message including information for determining whether the user equipment is allowed to transmit, to the network node, an MBS interest indication regarding an MBS session; and
determining whether to perform transmission processing of the MBS interest indication based on the information.

2. The communication method according to claim 1, wherein
the information is configuration information configuring a condition under which the user equipment is permitted to transmit, to the network node, the MBS interest indication.

3. The communication method according to claim 2, further comprising
not performing the transmission processing when the condition configured by the configuration information is not satisfied and performing the transmission processing in response to the condition configured by the configuration information being satisfied.

4. The communication method according to claim 3, wherein
the configuration information comprises trigger configuration information configuring a type of a trigger condition to be applied in the user equipment among a plurality of types of trigger conditions defined as trigger conditions under which transmission of the MBS interest indication is triggered, and
the performing of the transmission processing comprises triggering the transmission processing in response to the trigger condition of the type configured by the trigger configuration information among the plurality of types of trigger conditions being satisfied.

5. The communication method according to claim 3, wherein
the configuration information comprises prohibition time configuration information configuring a prohibition time from when an n-th (n≥1) MBS interest indication is transmitted to when an (n+1)-th MBS interest indication is capable of being transmitted, and
the performing of the transmission processing comprises transmitting a current MBS interest indication in response to the prohibition time configured by the prohibition time configuration information elapsing after transmitting a previous MBS interest indication.

6. The communication method according to claim 5, wherein
the configuration information further comprises trigger type information associated with the prohibition time configuration information, and
the trigger type information is information indicating a type of a trigger condition to which the prohibition time is to be applied among a plurality of types of trigger conditions defined as trigger conditions under which transmission of the MBS interest indication is triggered.

7. The communication method according to claim 6, wherein
the performing of the transmission processing comprises transmitting the previous MBS interest indication in response to the trigger condition of the type indicated by the trigger type information being satisfied and then transmitting the current MBS interest indication in response the prohibition time configured by the prohibition time configuration information elapsing and the trigger condition of the type indicated by the trigger type information being satisfied.

8. The communication method according to claim 3, wherein
the configuration information comprises dispersion information configured to disperse, in a time domain and/or a frequency domain, transmission of a plurality of MBS interest indications by a plurality of user equipments comprising the user equipment, and
the performing of the transmission processing comprises transmitting the MBS interest indication at a timing and/or a frequency determined based on the dispersion information.

9. The communication method according to claim 8, wherein
the configuration information further comprises trigger type information associated with the dispersion information, and
the performing of the transmission processing comprises transmitting the MBS interest indication at the timing and/or the frequency determined based on the dispersion information in response to the trigger condition of the type indicated by the trigger type information being satisfied.

10. The communication method according to claim 8, wherein
the dispersion information comprises cell information configuring a cell in which the user equipment transmits the MBS interest indication.

11. The communication method according to claim 8, wherein
the dispersion information comprises timing control information configured to control a timing at which the user equipment transmits the MBS interest indication.

12. The communication method according to claim 11, wherein
the performing of the transmission processing comprises determining the timing of transmitting the MBS interest indication based on the timing control information and an identifier unique to the user equipment.

13. The communication method according to claim 11, wherein
the performing of the transmission processing comprises determining the timing of transmitting the MBS interest indication based on the timing control information and a random number generated by the user equipment.

14. The communication method according to claim 11, wherein
the performing of the transmission processing comprises determining the timing of transmitting the MBS interest indication based on the timing control information and an MBS session start timing known by the user equipment.

15. A user equipment comprising:
a receiver configured to receive, from a network node, a broadcast message including information for determining whether the user equipment is allowed to transmit, to the network node, a multicast and broadcast service (MBS) interest indication regarding an MBS session; and
a controller configured to determine whether to perform transmission processing of the MBS interest indication based on the information.

16. A chipset for a user equipment, the chipset configured to execute processing of:
receiving, from a network node, a broadcast message including information for determining whether the user equipment is allowed to transmit, to the network node, a multicast and broadcast service (MBS) interest indication regarding an MBS session; and
determining whether to perform transmission processing of the MBS interest indication based on the information.

17. A non-transitory computer-readable medium comprising, stored thereupon, computer program instructions for execution by a user equipment, the program instructions being configured to cause the user equipment to execute processing of:
receiving, from a network node, a broadcast message including information for determining whether the user equipment is allowed to transmit, to the network node, a multicast and broadcast service (MBS) interest indication regarding an MBS session; and
determining whether to perform transmission processing of the MBS interest indication based on the information.

18. A mobile communication system providing a multicast and broadcast service (MBS), the mobile communication system comprising:
a user equipment configured to:
receive, from a network node, a broadcast message including information for determining whether the user equipment is allowed to transmit, to the network node, a multicast and broadcast service (MBS) interest indication regarding an MBS session; and
determine whether to perform transmission processing of the MBS interest indication based on the information.
